(19) United States
(12) Patent Application Publication
(10) Pub. No.: US 2019/0081310 A1
(43) Pub. Date: Mar. 14, 2019

(54) RIBBONBOND INTERCONNECTS FOR ELECTRIC VEHICLE BATTERY BLOCKS

(71) Applicant: SF Motors, Inc., Santa Clara, CA (US)

(72) Inventors: Nathalie Capati, Santa Clara, CA (US); Duanyang Wang, Santa Clara, CA (US); Jacob Heth, Santa Clara, CA (US); Binbin Chi, Santa Clara, CA (US)

(21) Appl. No.: 16/118,361

(22) Filed: Aug. 30, 2018

Related U.S. Application Data
(60) Provisional application No. 62/557,688, filed on Sep. 12, 2017.

(51) Int. Cl. H01M 2/20; H01M 2/10; H01M 2/34; B60L 11/18

(52) U.S. Cl. CPC H01M 2/206; H01M 2/1077; B60L 11/1879; B60L 11/1877; H01M 2/34

(57) ABSTRACT

Systems and methods for interconnecting battery blocks are disclosed. A plurality of battery blocks can include a first battery block and a second battery block. Each battery block can include a plurality of battery cells electrically connected and physically arranged to form a battery module for storing energy. A plurality of ribbonbond interconnects are produced to electrically connect a current collector of the first battery block with a current collector of the second battery block. Each ribbonbond interconnect can comprise a metallic strip to provide a flexible physical connection between the first battery block and the second battery block to allow movement between the first battery block and the second battery block. Each ribbonbond interconnect can break an electrical connection between the first battery block and the second battery block if an electrical current in the corresponding ribbonbond interconnect exceeds a predefined threshold.

### RELATED APPLICATION

The present application claims the benefit of priority under 35 U.S.C. § 119(e) to U.S. Provisional Application 62/557,688, titled “RIBBONBOND INTERCONNECTS”, filed on Sep. 12, 2017. The entire disclosure of which is incorporated herein by reference in its entirety.

### BACKGROUND

Vehicles such as automobiles can include power sources. The power sources can power motors or other systems of the vehicles.

### SUMMARY

In at least one aspect, a system to interconnect battery blocks is provided. The system can include a plurality of battery blocks. The plurality of battery blocks can be disposed within an electric vehicle to power the electric vehicle. Each of the plurality of battery blocks can include a plurality of battery cells electrically connected and physically arranged to form a battery module for storing energy. A first plurality of ribbonbond interconnects can electrically connect a current collector of a first battery block of the plurality of battery blocks with a current collector of a second battery block of the plurality of battery blocks. Each ribbonbond interconnect can include a flexible metallic strip. The flexible metallic strip can provide a flexible physical connection between the first battery block and the second battery block to allow movement between the first battery block and the second battery block. The flexible metallic strip can break an electrical connection between the first battery block and the second battery block responsive to an electrical current in the corresponding ribbonbond interconnect exceeding a threshold. The threshold can be lower than a threshold of the first battery block for breaking an electrical connection between a terminal of one of the plurality of battery cells of the first battery block and the current collector of the first battery block.

In at least one aspect, a method of interconnecting battery blocks to power an electric vehicle is provided. The method can include arranging a plurality of battery blocks relative to each other in an electric vehicle to power the electric vehicle. Each of the plurality of battery blocks can include a plurality of battery cells electrically connected and physically arranged to form a battery module for storing energy. The method can include producing a first plurality of ribbonbond interconnects according to the arrangement. Each of the first plurality of ribbonbond interconnects can have a threshold for electrical current flow. The method can include electrically connecting a current collector of a first battery block of the plurality of battery blocks with a current collector of a second battery block of the plurality of battery blocks using the first plurality of ribbonbond interconnects. Each of the ribbonbond interconnects can include a flexible metallic strip. The flexible metallic strip can provide a flexible physical connection between the first battery block and the second battery block. The flexible metallic strip can break an electrical connection between the first battery block and the second battery block when an electrical current in the corresponding ribbonbond interconnect exceeds the threshold. The threshold can be lower than a first battery block threshold for breaking an electrical connection between a terminal of one of the plurality of battery cells and a first current collector of the first battery block.

In at least one aspect, a method is provided. The method can include providing a system for interconnecting battery blocks that can power an electric vehicle. Each of the plurality of battery blocks can include a plurality of battery cells electrically connected and physically arranged to form a battery module for storing energy. A first plurality of ribbonbond interconnects can electrically connect a current collector of a first battery block of the plurality of battery blocks with a current collector of a second battery block of the plurality of battery blocks. Each ribbonbond interconnect can include a flexible metallic strip. The flexible metallic strip can provide a flexible physical connection between the first battery block and the second battery block to allow movement between the first battery block and the second battery block. The flexible metallic strip can break an electrical connection between the first battery block and the second battery block responsive to an electrical current in the corresponding ribbonbond interconnect exceeding a threshold. The threshold can be lower than a threshold of the first battery block for breaking an electrical connection between a terminal of one of the plurality of battery cells of the first battery block and the current collector of the first battery block.

In at least one aspect, an electric vehicle is provided. The electric vehicle can include a plurality of battery blocks disposed in the electric vehicle to power the electric vehicle. The plurality of battery blocks can be disposed within the electric vehicle to power the electric vehicle. Each of the plurality of battery blocks can include a plurality of battery cells electrically connected and physically arranged to form a battery module for storing energy. A first plurality of ribbonbond interconnects can electrically connect a current collector of a first battery block of the plurality of battery blocks with a current collector of a second battery block of the plurality of battery blocks. Each ribbonbond interconnect can include a flexible metallic strip. The flexible metallic strip can provide a flexible physical connection between the first battery block and the second battery block to allow movement between the first battery block and the second battery block. The flexible metallic strip can break an electrical connection between the first battery block and the second battery block responsive to an electrical current in the corresponding ribbonbond interconnect exceeding a threshold. The threshold can be lower than a threshold of the first battery block for breaking an electrical connection between a terminal of one of the plurality of battery cells of the first battery block and the current collector of the first battery block.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not necessarily intended to be drawn to scale. Like reference numbers and designations in the various drawings indicate like elements. For purposes of clarity, not every component may be labelled in every drawing. In the drawings:

FIG. 1 depicts an isometric view of an illustrative embodiment of a battery block for providing energy storage;

FIG. 2 depicts an isometric view of an illustrative embodiment of a system for interconnecting battery blocks;

FIG. 3 depicts an exploded view of a top view of an illustrative embodiment of a system for providing energy storage;

FIG. 4 depicts an illustrative embodiment of a battery pack for providing energy storage;

FIG. 5 is a block diagram depicting a cross-sectional view of an example electric vehicle installed with a battery pack;

FIG. 6 is a flow diagram depicting an illustrative embodiment of a method for interconnecting battery blocks; and

FIG. 7 is a flow diagram depicting an illustrative embodiment of a method for providing battery blocks.

### DETAILED DESCRIPTION

Following below are more detailed descriptions of various concepts related to, and implementations of, methods, apparatuses, devices, and systems for energy storage. The various concepts introduced above and discussed in greater detail below may be implemented in any of numerous ways.

With reference to the FIGS., the systems, methods, devices, and apparatuses of the present disclosure relate generally to battery related energy storage devices, including but not limited to battery modules.

Systems and methods described herein are directed towards interconnects designed and implemented to provide electrical connections between battery blocks of battery modules or battery packs used to power electric vehicle (EV) systems. The interconnects can include ribbonbond interconnects (e.g., ribbon bonding connections and conductors) that can electrically couple one or more battery blocks with one or more different battery blocks, with each of the battery block having multiple battery cells. The ribbonbond interconnects can carry current between the different battery blocks. For example, the ribbonbond interconnects can be formed such that they have a maximum current carrying capability specified for required continuous current and be designed and implemented to break (e.g., break an electrical connection) under unwanted high current conditions. The ribbonbond interconnects can act as a mechanical fuse between a first battery block and a second, different battery block.

The ribbonbond interconnects can provide a flexible physical connection between the first battery block and the second battery block to allow movement between the first battery block and the second battery block. For example, the movement can include lateral movement or twisting of the respective battery blocks with respect to each other. The ribbonbond interconnects can be designed or implemented to break an electrical connection between the first battery block and the second battery block responsive to an electrical current or flow in the corresponding ribbonbond interconnect exceeding a threshold. The threshold can be based in part on a size and length of the respective ribbonbond. For example, depending on the size and length of the ribbonbond, the current capability of the respective ribbonbond can change. The thermal fatigue or mechanical fatigue of the ribbon can be used to determine an appropriate size of a ribbonbond. The threshold or instant fuse current can be in a range from 40 amps to 250 amps. For example, a ribbonbond having dimensions of a width of 2 mm, a thickness of 0.3 m, and a length of 15 mm can have a threshold of instant fuse current of 100 amps. The threshold can be lower than that for breaking (e.g., damaging, melting or otherwise creating a failure in) an electrical connection between a terminal (e.g., positive terminal, or negative terminal) of one of the plurality of battery cells and the current collector of the first battery block or second battery block. The ribbonbond interconnects as described here can be used to electrically couple different battery blocks, as compared to bolted or welded fix connections. The ribbonbond interconnects can provide or allow for easier rework of interconnects between battery blocks and higher yield rates in manufacturing such interconnected battery blocks.

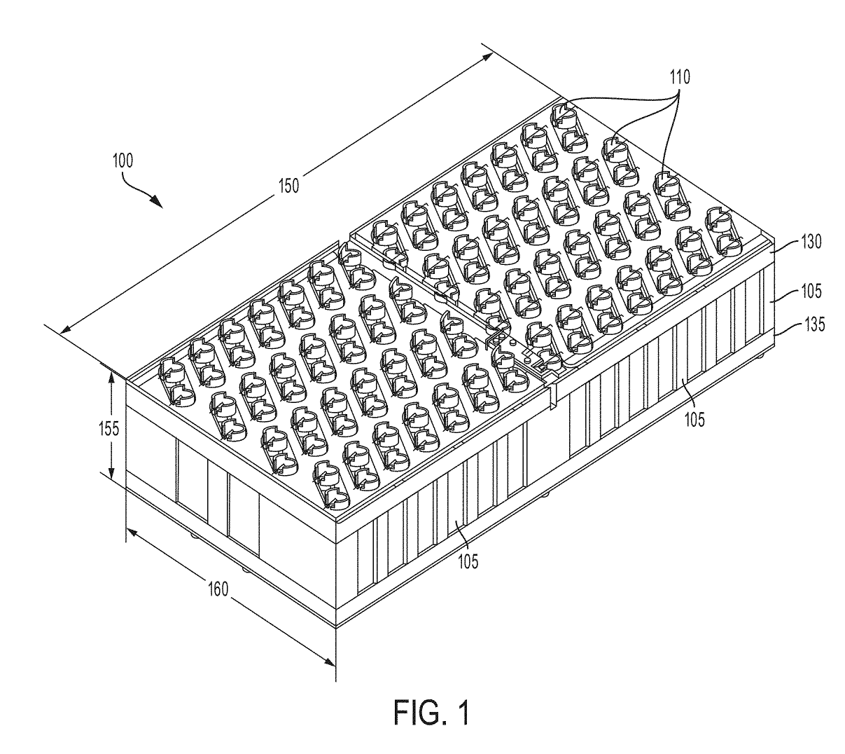

FIG. 1, among others, depicts an example system to power electric vehicles. In FIG. 1, a battery module 100 is provided having two battery blocks 105 (e.g., a first battery block 105 and a second battery block 105). The first and second battery blocks 105 can be subcomponents of the battery module 100. A battery module 100 as described herein can refer to a battery system having multiple battery blocks 105 (e.g., two or more). For example, multiple battery blocks 105 can be electrically coupled with each other to form a battery module 100. The battery modules 100 can be formed having a variety of different shapes. For example, the shape of the battery modules 100 can be determined or selected to accommodate a battery pack within which a respective battery module 100 is to be disposed. The shape of the battery modules 100 may include, but not limited to, a square shape, rectangular shape, circular shape, or a triangular shape. Battery modules 100 in a common battery pack can have the same shape. One or more battery modules 100 in a common battery pack can have a different shape from one or more other battery modules 100 in the common battery pack.

Battery blocks 105 can be held together using one or more cell holders 130, 135. For example, a single one of cell holders 130, 135 can house at least two battery blocks 105 in a single plastic housing. The battery cells 110 can be positioned within the respective one of the cell holder 130, 135 using adhesive material (e.g., 2-part epoxy, silicone-based glue, or other liquid adhesive), heat staking, or press fit. The battery cells 110 can be positioned within the respective one of the cell holder 130, 135 to hold them in place. For example, the battery cells 110 can have a tolerance in height as part of the manufacturing process. This tolerance can be accounted for by locating either the top or bottom of the respective battery cells 110 to a common plane and fixing them there within the respective one of the cell holder 130, 135. For example, a bottom end of each of the battery cells 110 can be positioned flat relative to each other to provide a flat mating surface to a cold plate. The top end of the battery cells 110 can be positioned flat relative to the first cell holder 130 to provide or form a flat plane for forming battery cell to current collector connections (e.g., wirebonding, laser welding). The flat plane may only be provided on a top or bottom plane of the battery cells 110 because the cell holders 130, 135 can be retained in the respective battery module 100 using adhesive material (e.g., 2-part epoxy, silicone-based glue, or other liquid adhesive), bolts/fasteners, pressure sensitive adhesive (PSA) tape, or a combination of these materials. The structure of the battery module 100 that the cell holders 130, 135 are placed in or disposed in can include a stamped, bent, or formed metal housing or could be a plastic housing made by injection molding or another manufacturing method. The electrical connections between battery blocks 105 and battery modules 100 can use aluminum or copper busbars (stamped/cut metallic pieces in various shapes) with fasteners, wires and ribbons (aluminum, copper, or combination of the two), press fit studs and connectors with copper cables, or bent/formed/stamped copper or aluminum plates.

The number of battery blocks 105 in a battery module 100 can vary and can be selected based at least in part on an amount of energy or power to be provided to an electric vehicle. For example, the battery module 100 can couple with one or more bus-bars within a battery pack or couple with a battery pack of an electric vehicle to provide electrical power to other electrical components of the electric vehicle. The battery module 100 includes multiple battery blocks 105. The battery module 100 can include multiple cell holders 130, 135 to hold or couple the battery blocks 105 together, and to couple the battery cells 110 to form the battery blocks 105 together. The first and second battery blocks 105 can include a plurality of battery cells 110. The battery cells can be homogeneous or heterogeneous in one or more aspects, such as height, shape, voltage, energy capacity, location of terminal(s) and so on. The first battery block 105 may include the same number of battery cells 110 as the second battery block, or the first battery block 105 may have a different number of battery cells 110 (e.g., greater than, less than) the second battery block 105. The first and second battery blocks 105 can include any number of battery cells 110 arranged in any configuration (e.g., an array of N×N or N×M battery cells, where N, M are integers). For example, a battery block 105 may include two battery cell 110 or fifty battery cells 110. The number of battery cells 110 included within a battery block 105 can vary within or outside this range. The number of battery cells 110 included within a battery block 105 can vary based in part on battery cell level specifications, battery module level requirements, battery pack level requirements or a combination of these that you are trying to obtain or reach with the respective battery block 105. The number of battery cells 110 to include in a particular battery block 105 can be determined based at least in part on a desired capacity of the battery block 105 or a particular application of the battery block 105. For example, a battery block 105 can contain a fixed “p” amount of battery cells, connected electrically in parallel which can provide a battery block capacity of “p” times that of the single battery cell capacity. The voltage of the respective battery block 105 (or cell block) can be the same as that of the single battery cell 110 (e.g., 0V to 5V or other ranges), which could be treated as larger cells that can be connected in series into the battery module 100 for battery packs for example. For example, the plurality of cylindrical battery cells 110 can provide a battery block capacity to store energy that is at least five times greater than a battery cell capacity of each of the plurality of cylindrical battery cells 110. The battery blocks 105 can have a voltage of up to 5 volts across the pair of battery block terminals of the respective battery block 105.

The battery blocks 105 can each include one or more battery cells 110 and each of the plurality of battery cells 110 can have a voltage of up to 5 volts (or other limit) across terminals of the corresponding battery cell. For example, the battery blocks 105 can include an arrangement of a plurality of battery cells 110 electrically connected in parallel. Each cell of the plurality of battery cells can be spatially separated from each of at least one adjacent cell by, for example, two millimeter (mm) or less. The arrangement of the plurality of battery cells can form a battery block 105 for storing energy and can have a voltage of up to 5 volts across terminals of the respective battery block 105. For instance, a single battery cell 110 can have a maximum voltage of 4.2V (or 5V, or some other value), and the corresponding battery block 105 can have a maximum voltage of 4.2V (or 5V, or some other value). By way of an example, a battery block 105 using 5 volts/5 Ampere-hour (5V/5 Ah) cells with 60 cells in parallel can become a 0V to 5V, 300 Ah modular unit. The battery block 105 can have high packaging efficiency by utilizing the minimum cell to cell spacing (e.g., any value from 0.3 mm to 2 mm) that prevents thermal propagation within the block with each cell having an individual and isolated vent port for instance. For example, spatial separation between adjacent cells of less than 1 mm can be implemented in the present battery blocks 105. The battery block 105 can thus be small, e.g., less than 0.05 cubic feet, giving it a high volumetric energy density for high packing efficiency.

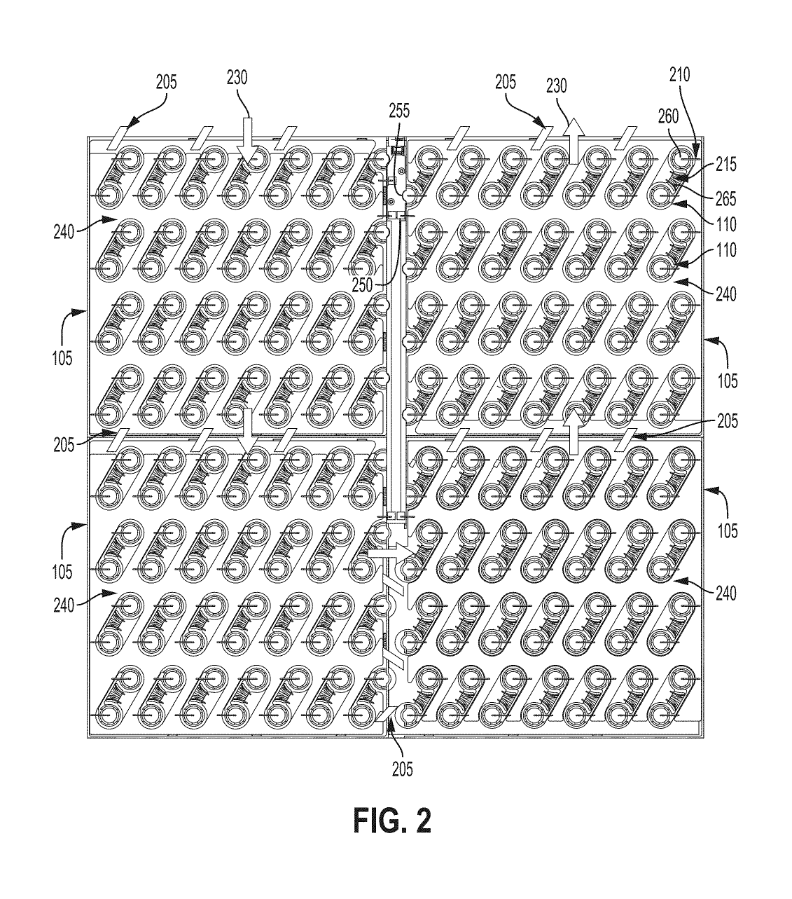

The battery block 105 can include battery cells 110 physically arranged in parallel to each other along the longest dimension of each battery cell 110. The battery cells 110 can be arranged physically as a two dimensional array of battery cells 110 (e.g., as shown in FIGS. 1-2), or can be arranged physically as a three dimensional array of battery cells 110. For example, the battery cells 110 can be arranged in an array formation having three values, such as a length value 150, a height value (or depth value) 155, and a width value 160 to form the battery block 105 or battery module 100. As depicted in FIG. 1, the battery module 100 can have a dimension of length 150×width 160×height 155. The battery block 105 can have a length value 150 of 200 mm, a width value 160 of 650 mm, and a height value 155 of 100 mm. The length 150 may range from 25 mm to 700 mm. The width 160 may range from 25 mm to 700 mm. The height 155 (or depth) may range from 65 mm to 150 mm. The height 155 of the battery block 105 or battery module 100 may correspond to (or be dictated by) the height or longest dimension of a component the battery cell 110.

The battery blocks 105 may form or include an enclosure or housing. For example, the plurality of battery cells 110 can be enclosed in an battery block enclosure. The battery block enclosure can be formed in a variety of different shapes, such as but not limited to, a rectangular shape, a square shape or a circular shape. The battery block enclosure can be formed having a tray like shape and can include a raised edge or border region. The battery cells 110 can be held in position by the raised edge or border region of the battery block enclosure. The battery block enclosure can be coupled with, in contact with, or disposed about the plurality of battery cells 110 to enclose the plurality of battery cells 110. For example, the battery block enclosure can be formed such that it at least partially surrounds or encloses each of the battery cells 110. The battery block enclosure can be less than 1 cubic feet in volume. For example, the battery block 105 enclosure can be less than 0.05 cubic feet in volume. The battery block 105 enclosure can be configured to be less than 0.15 cubic feet in volume.

The battery cells 110 can be provided or disposed in the first and second battery blocks 105 and can be arranged in one or more rows and one or more columns of battery cells 110. Each of the rows or columns of battery cells 110 can include the same number of battery cells 110 or they can include a different number of battery cells 110. The battery cells 110 can be arranged spatially relative to one another to reduce overall volume of the battery block 105, to allow for minimum cell to cell spacing (e.g., without failure or degradation in performance), or to allow for an adequate number of vent ports. The rows of battery cells 110 can be arranged in a slanted, staggered or offset formation relative to one another (see FIG. 2). The battery cells 110 can be placed in various other formations or arrangements.

Each of the battery cells 110 in a common battery block 105 (e.g., same battery block 105) can be spaced from a neighboring or adjacent battery cell 110 in all directions by a distance that ranges from 0.5 mm to 3 mm (e.g., 1.5 mm spacing between each battery cell 110, 2 mm spacing between each battery cell 110). The battery cells 110 in a common battery block 105 can be uniformly or evenly spaced. For example, each of the battery cells 110 can be spaced the same distance from one or more other battery cells 110 in the battery blocks 105. One or more battery cells 110 in a common battery block 105 can be spaced one or more different distances from another one or more battery cells 110 of the common battery block 105. Adjacent battery cells 110 between different battery blocks 105 can be spaced a distance in a range from 2 mm to 6 mm. The distances between the battery cells 110 of different battery blocks 105 can vary across applications and configurations, and can be selected based at least in part on the dimensions of the battery blocks 105, electrical clearance or creepage specifications, or manufacturing tolerances for the respective battery module 100.

The battery block 105 can provide a battery block capacity of up to 300 Ampere-hour (Ah) or more. The battery block 105 can provide varying capacity values. For example, the battery block 105 can provide a capacity value that corresponds to a total number of cylindrical battery cells 110 in the plurality of cylindrical battery cells 110 forming the respective battery block 105. For example, the battery block 105 can provide a battery block capacity in a range from 8 Ah to 600 Ah.

The battery blocks 105 can be formed having a variety of different shapes. For example, the shape of the battery blocks 105 can be determined or selected to accommodate a battery module 100 or battery pack within which a respective battery block 105 is to be disposed. The shape of the battery blocks 105 may include, but not limited to, a square shape, rectangular shape, circular shape, or a triangular shape. Battery blocks 105 in a common battery module 100 can have the same shape or one or more battery blocks 105 in a common battery module 100 can have a different shape from one or more other battery blocks 105 in the common battery module 100.

The battery blocks 105 can each include at least one cell holder 130, 135 (sometimes referred as a cell holder). For example, the first and second battery blocks 105 can each include a first cell holder 130 and a second cell holder 135. The first cell holder 130 and the second cell holder 135 can house, support, hold, position, or arrange the battery cells 110 to form the first or second battery blocks 105 and may be referred to herein as structural layers. For example, the first cell holder 130 and the second cell holder 135 can hold the battery cells 110 in predetermined positions or in a predetermined arrangement to provide the above described spatial separation (e.g., spacing) between each of the battery cells 110. The first cell holder 130 can couple with or be disposed on or over a top surface of each of the battery cells 110. The second cell holder can couple with or contact a bottom surface of the each of the battery cells 110.

The first cell holder 130 and the second cell holder 135 can include one or more recesses, cutouts or other forms of holes or apertures designed and implemented to hold portions of the battery cells 110. The recesses, cutouts or other forms of holes or apertures of the first and second cell holder s 130, 135 can be formed to conform or match with, or correspond to the dimensions of the battery cells 110. For example, each of the recesses, cutouts or other forms of holes or apertures can have the same dimensions (e.g., same diameter, same width, same length) as each of the battery cells 110 to be disposed within the respective recess, cutout, or other forms of holes or apertures. The battery cells 110 can be disposed within the recesses, cutouts or other forms of holes or apertures such that they are flush with an inner surface of the recesses, cutouts or other forms of holes or apertures. For example, an outer surface of each of the battery cells 110 can be in contact with the inner surface of the recesses, cutouts or other forms of holes or apertures of each of the first and second cell holder s 130, 135 when the battery cells 110 are disposed within or coupled with the recesses, cutouts or other forms of holes or apertures of each of the first and second cell holder s 130, 135.

The battery module 100 can include a single battery block 105 or multiple battery blocks 105 (e.g., two battery blocks 105, or more than two battery blocks 105). The number of battery blocks 105 in a battery module 100 can be selected based at least in part on a desired capacity, configuration or rating (e.g., voltage, current) of the battery module 100 or a particular application of the battery module 100. For example, a battery module 100 can have a battery module capacity that is greater than the battery block capacity forming the respective battery module 100. The battery module 100 can have a battery module voltage greater than the voltage across the battery block terminals of the battery block 105 within the respective battery module 100. The battery blocks 105 can be positioned adjacent to each other, next to each other, stacked, or in contact with each other to form the battery module 100. For example, the battery blocks 105 can be positioned such that a side surface of the first battery block 105 is in contact with a side surface of the second battery block 105. The battery module 100 may include more than two battery blocks 105. For example, the first battery blocks 105 can have multiple side surfaces positioned adjacent to or in contact with multiple side surfaces of other battery blocks 105. Various types of connectors can couple the battery blocks 105 together within the battery module 100. In addition to ribbonbond interconnects for instance, the connectors may include, but not limited to, straps, wires, adhesive layers, or fasteners.

FIG. 2 depicts a top view of a battery module 100 illustrating an example arrangement of the battery cells 110 in each of a first battery block 105, a second battery block 105, a third battery block 105, and a fourth battery block 105. The battery blocks 105 are coupled with through a plurality of ribbonbond interconnects 205. The plurality of ribbonbond interconnects 205 can be used to couple at least two battery blocks 105. For example, ribbonbond interconnects 205 can couple positive current collectors with negative current collectors of the battery blocks 105 such that the battery blocks 105 are coupled in series in a “U” shape as illustrated in by arrows 230. For example, a first ribbonbond interconnect 205 (or first plurality of ribbonbond interconnects 205) of a first battery block 105 can correspond to a negative terminal of the battery module 100. A second ribbonbond interconnect 205 (or second plurality of ribbonbond interconnects 205) can couple a positive terminal of the first battery block 105 with a negative terminal of a second battery block 105 to couple the first battery block 105 is series with the second battery block 105. A third ribbonbond interconnect 205 (or third plurality of ribbonbond interconnects 205) can couple a positive terminal of the second battery block 105 with a negative terminal of a third battery block 105 to couple the second battery block 105 is series with the third battery block 105. A fourth ribbonbond interconnect 205 (or third plurality of ribbonbond interconnects 205) can couple a positive terminal of the third battery block 105 with a negative terminal of a fourth battery block 105 to couple the third battery block 105 is series with the fourth battery block 105. A fifth ribbonbond interconnect 205 (or fifth plurality of ribbonbond interconnects 205) of the fourth battery block 105 can correspond to a positive terminal of the battery module 100. Thus, the first, second, third, and fourth battery blocks 105 can couple in series using the ribbonbond interconnects 205.

FIG. 2 shows a layer or surface 240 of each of the battery blocks 105 electrically coupled with each other through the ribbonbond interconnects 205. The layer or surface 240 can correspond to a positive current collector of the respective battery blocks 105 or negative current collectors of the respective battery blocks 105. Thus, the ribbonbond interconnects 205 can be used to connect the positive current collectors of the battery blocks 105 or the negative current collectors of the battery blocks 105, or can be used to couple both the positive current collectors of the battery blocks 105 and the negative current collectors of the battery blocks 105. The battery block 105 can be coupled in parallel with respect to each other. For example, a first plurality of ribbonbond interconnects 205 can be used to connect positive current collectors of the battery blocks 105, and a second plurality of ribbonbond interconnects 205 can be used to connect negative current collectors of the battery blocks 105. A ribbonbond interconnect 205 may sometimes be referred herein as an interconnect implemented via ribbon bonding, or generally referred herein as an interconnect or a ribbon bond.

The ribbonbond interconnects 205 can make an electrical connection between at least two different battery blocks 105 and carry current between the respective battery blocks 105. The ribbonbond interconnects 205 can be designed or formed having a maximum current carrying threshold or capability such that the ribbonbond interconnects 205 can break or otherwise disconnect the electrical connection between the respective battery blocks 105 when the current flowing through the respective ribbonbond interconnect 205 reaches or exceeds the maximum current carrying threshold or capability of the respective ribbonbond interconnect 205. The threshold can be based in part on a size and length of the respective ribbonbond interconnect 205. For example, depending on the size and length of the ribbonbond interconnect 205, the current capability of the respective ribbonbond can change. The thermal fatigue or mechanical fatigue of the ribbon can be used to determine an appropriate size of a ribbonbond interconnect 205. The threshold or instant fuse current of the ribbonbond interconnect 205 can be in a range from 40 amps to 250 amps. For example, an aluminum ribbonbond having dimensions of a width of 2 mm, a thickness of 0.3 m, and a length of 15 mm can have a threshold of instant fuse current of 100 amps.

The ribbonbond interconnects 205 maximum current carrying threshold or capability can be predetermined, selected, designed, or implemented to break (e.g., disconnect, burn out, melt, disintegrate, or otherwise provide an open circuit connection) under predefined (e.g., unwanted) high current condition(s). A high current condition can vary and the particular amount of a high current condition can be based at least in part on a particular application of the battery blocks 105, a battery module 100, or a battery pack 405. Such predefined high current condition(s) can be specified for continuous current, instantaneous current, average current, etc., in various embodiments.

The ribbonbond interconnect 205 can act or function as a mechanical fuse between two battery blocks 105 that the ribbonbond interconnect 205 connects. Multiple ribbonbond interconnects 205 between two battery blocks 105 can implemented with predefined high current condition(s) taking into consideration the current flow distributed across these ribbonbond interconnects 205. For example, if a 1000 Amps current rating is desired, and a ribbonbond interconnect 205 with a fuse rating of 100 Amps is chosen, then eleven or more of the ribbonbond interconnects 205 with a fuse rating of 100 Amps can be couple between two battery blocks 105 in parallel to meet the high current condition of 1000 Amps. Based on a current flow distribution and number of cycles needed, more than eleven ribbonbond interconnects 205 with a fuse rating of 100 A can be used for the high current condition of 1000 Amps. High current conditions for an electric vehicle can be, for example, as high as 3000 Amps. Thus, a high current condition can range from 1000 Amps to 3000 Amps. The high current condition can vary within or outside this range. The ribbonbond interconnect 205 (or ribbon bonding) can enable easier rework (e.g., removal, replacement) of interconnects between battery blocks 105, and can provide higher yield rates in manufacturing as compared to other interconnects such as bolted or welded bus bar interconnects. The latter connections are rigid and can be susceptible to overheating or reliability issues (e.g., under structural perturbations).

The ribbonbond interconnect 205 can include or be formed from a conductive material, metallic material or metal materials, such as but not limited to aluminum, pure aluminum, copper, or aluminum clad copper. The ribbonbond interconnect 205 can have a thickness in a range from 8 mils to 20 mils (e.g., 0.2 mm to 1 mm). For example, the ribbonbond interconnects 205 can include or be formed from a thin metallic strip, that can be welded or bonded (e.g., ultrasonic welded, or otherwise) from a first current collector (e.g., positive current collector, negative current collector) of a first battery block 105 to a second current collector (e.g., positive current collector, negative current collector) of a second battery block 105.

The ribbonbond interconnects 205 made from a metallic strip can have a smaller footprint, and can be more durable, e.g., as compared to a bus bar or other types of interconnects. The metallic strip can be fixed compactly and accurately at weld points on battery blocks. A small footprint can be advantageous by using or occupying a small area to make an electrical connection. Multiple ribbonbond interconnects 205 can be coupled with, connected to, or attached in the same area (e.g., overlaid weld points, layered ribbonbond interconnects, stacked ribbonbond interconnects) or common area of a battery block 105, which can be beneficial for at least one of providing redundancy and improving heat dissipation (e.g., as compared to a single bus bar or cable connection). Multiple ribbonbond interconnects 205 coupled with, connected to, or attached in the same area (e.g., overlaid weld points, layered ribbonbond interconnects, stacked ribbonbond interconnects) or common area of a battery block 105 can allow for more space on a surface of the respective battery block 105 for weld points. For example, one or more ribbonbond interconnects 205 can be disposed over one or more other, different ribbonbond interconnects 205 to form a stacked portion or layered portion of a plurality of ribbonbond interconnects 205. At least one surface (e.g., top surface, bottom surface) of a first ribbonbond interconnect 205 of the first plurality of ribbonbond interconnects 205 can be disposed over at least one surface (e.g., top surface, bottom surface) of a second ribbonbond interconnect 205 (e.g., different from the first ribbonbond interconnect) of the plurality of ribbonbond interconnects 205 to form a stacked portion of the first plurality of ribbonbond interconnects 205. The first ribbonbond interconnect 205 can be disposed such that at least one surface or portions of at least one surface is in contact with at least one surface or portions of the second ribbonbond interconnect 205 to form the stacked portion or layered portion of a plurality of ribbonbond interconnects 205. The plurality of ribbonbond interconnects 205 can include a single stacked portion or layer portion. The plurality of ribbonbond interconnects 205 can include multiple stacked portions or layer portions. The stacked portion or layer portion of ribbonbond interconnects 205 can include at least two ribbonbond interconnects 205 stacked or layered on top of each other or more than ribbonbond interconnects 205 stacked or layered on top of each other.

The ribbonbond interconnects 205 can be formed having a predetermined length or can be made or drawn to a desired length. The ribbonbond interconnects 205 length can vary based at least in part on a particular application of the respective ribbonbond interconnects 205. The ribbonbond interconnects 205 can be formed having a length in a range from 3 mm to 50 mm. The length of the ribbonbond interconnects 205 can vary within or outside this range. The ribbonbond interconnects 205 can flexible or have a predetermined flexibility rating (e.g., not rigid) to allow for motion in multiple planes (e.g., x-plane, y-plane, z-plane). For example, the ribbonbond interconnects 205 can be flexible to allow directional movement in the x-plane, the y-plane, or the z-plane (e.g., within 5 millimeter in a z direction, or the same or other levels of spatial displacement in one or more directions). The ribbonbond interconnects 205 can be disposed between battery blocks 105 to allow relative movement between the battery blocks 105, and the freedom of movement can protect or provide resilience against shock and vibration, for example, when the battery blocks 105 are disposed within a drive unit of an electric vehicle and during operation of the electric vehicle. For example, the ribbonbond interconnects 205 can include or be formed as a thin metallic strip, that can be welded (e.g., ultrasonic welded) from one battery block 105 current collector (e.g., of a first polarity, such as positive polarity) to another battery block 105 current collector (e.g., of a second, different polarity, such as negative polarity). The metallic strip can be formed having a small footprint, while maintaining the metallic strip's durability, and can be fixed only at the weld points. The small footprint (e.g., thickness in a range from 0.2 mm to 1 mm) can be advantageous because it does not require the entire area to make an electrical connection. Thus multiple ribbonbond interconnects 205 (e.g., multiple ribbon bonds) can be coupled with or attached in the same area which is good for redundancy and heat dissipation. The ribbonbond interconnects can be formed having a predetermined length and certain degree of flexibility (e.g., not rigid), to allow for motion in multiple planes, such as at least one of x-direction movement, y-directional movement, or and z-directional movement (e.g., <5 mm in z movement). The movement may include rotational movement of a first battery block 105 relative to a second battery block 105. The movement may include lateral or side-to-side movement of a first battery block 105 relative to a second battery block 105. The movement may include twisting movement of a first battery block 105 relative to a second battery block 105. The movement may include movement in a single plane of motion or multiple planes of motion of a first battery block 105 relative to a second battery block 105.

Thus, the ribbonbond interconnects 205 can protect or provide resilience against shock and vibration and can move relative to the battery blocks they are coupled with. For example, the ribbonbond interconnects 205 (e.g., the metallic strips) can provide a level of elasticity to protect or provide resilience against shock and vibration. The ribbonbond interconnect 205 can have a flexibility or elasticity rating of 10% elongation to 20% elongation before breaking. The ribbonbond interconnects 205 can be coated or electroplated with a coating material or coating layer that is a different material than the material of the ribbonbond interconnects 205. For example, the ribbonbond interconnects 205 can be coated or electroplated with a metallic material, such as but not limited to nickel. The coating material or coating layer can for instance add strength, resilience against physical failure (e.g., at the welding or bonding points), or alter conductivity characteristics of the respective ribbonbond interconnect 205. The flexibility of the ribbonbond interconnect 205 allows for a ribbonbond interconnect 205 to couple two battery blocks 105 with some slack or ability for movement of the ribbonbond interconnect 205 or of the interconnected battery blocks 105 without breaking an electrical connection, for example.

The ribbonbond interconnects 205 can couple the plurality of battery blocks 105 in series and form a current path 230 having a predetermined shape. The current path 230 can correspond to the flow of current from one battery block 105 to a second, different battery block 105 in a plurality of battery blocks 105. The shape of the current path 230 can vary and be formed based at least in part on the arrangement of the battery blocks 105. For example, and as depicted in FIG. 2, the current path 230 has a “U” shape and the battery blocks 105 are arranged in series within a square or rectangular footprint. The current path 230 begins with the first battery block 105, which is coupled with the second battery block 105, the second battery block 105 is coupled with the third battery block 105, and the third battery block 105 is coupled with the fourth battery block 105, each through the first plurality of ribbonbond interconnects 205 in a current path 230 having the “U” shape. The current shape 230 can correspond to a series electrical connection between the a plurality of battery blocks 105. For example, if the battery blocks 105 are coupled, positioned, or arranged in a straight line, the current path 230 could be formed having a straight line shape. If the battery blocks 105 are coupled, positioned, or arranged in a circular shape, the current path 230 could be formed having a circular shape.

The ribbonbond interconnects 205 can include ribbonbond interconnects 205 for connecting between current collectors of the same electrical polarity (e.g., positive or negative) or voltage level. For example, the positive ribbonbond interconnects 205 can be used to couple a positive current collector (e.g., positive conductive layer) of a first battery block 105 with a positive current collector of a second, different battery block 105. The negative ribbonbond interconnects 205 can be used to couple a negative current collector (e.g., negative conductive layer) of a first battery block 105 with a negative current collector of a second, different battery block 105. The positive ribbonbond interconnects 205 can be same as or similar to the negative ribbonbond interconnects 205 (e.g., similar material, similar lengths), however the positive ribbonbond interconnects 205 can couple positive surfaces or layers and the negative ribbonbond interconnects 205 can couple negative surfaces of layers.

As depicted in FIG. 2, the battery blocks 105 can include a pair of terminals 250, 255. For example, the battery blocks 105 include a first battery block terminal 250 and a second battery block terminal 255. The first battery block terminal 250 can correspond to a positive terminal and the second battery block terminal 255 can correspond to a negative terminal. The plurality of cylindrical battery cells 110 can provide a battery block capacity to store energy that is at least five times greater than a battery cell capacity of each of the plurality of cylindrical battery cells 110. The battery blocks 105 can have a voltage of up to 5 volts across the pair of battery block terminals 250, 255. For example, the first battery block terminal 250 can be coupled with 5V and the second battery block terminal 255 can be coupled with 0 v. The first battery block terminal 250 can be coupled with +2.5V and the second battery block terminal 255 can be coupled with −2.5V. Thus, a difference in voltage between the first battery block terminal 250 and the second battery block terminal 255 can be 5V or up to 5V. The ribbonbond interconnects 205 can correspond to the battery block terminals. For example, a first ribbonbond interconnect 205 can correspond to a positive terminal of the respective battery block 105 and a second ribbonbond interconnect 205 correspond to a negative terminal of the respective battery block 105. The plurality of cylindrical battery cells 110 can provide a battery block capacity to store energy that is at least five times greater than a battery cell capacity of each of the plurality of cylindrical battery cells 110. The battery blocks 105 can have a voltage of up to 5 volts across the pair of ribbonbond interconnects 205. For example, the first ribbonbond interconnect 205 can couple with 5V and the second ribbonbond interconnect 205 can be couple with 0 v. The first ribbonbond interconnect 205 can be coupled with +2.5V and the second ribbonbond interconnect 205 can be coupled with −2.5V. Thus, a difference in voltage between the first ribbonbond interconnect 205 and the second ribbonbond interconnect 205 can be 5V or up to 5V.

The battery cells 110 in the battery blocks 105 can be arranged in one or more rows and one or more columns of battery cells 110. The individual battery cells 110 can be cylindrical cells or other types of cells. Depending on the shape of each battery cell 110, the battery cells 110 can be arranged spatially relative to one another to reduce overall volume of the battery block 105, to minimize cell to cell spacing (e.g., without failure or degradation in performance), or to allow for an adequate number of vent ports. For instance, FIG. 2, among others, shows each row of battery cells 110 arranged in a slanted or offset formation relative to one another. The battery cells 110 can be placed in various other formations or arrangements.

Each of the battery cells 110 in a common battery block 105 (e.g., same battery block 105) can be spaced from a neighboring or adjacent battery cell 110 in all directions by a distance that ranges from 0.5 mm to 3 mm (e.g., 1.5 mm spacing between each battery cell 110, 2 mm spacing between each battery cell 110). For example, a first battery cell 110 can be spaced a distance of 1.5 mm from a neighboring second battery cell 110 and spaced a distance of 1.5 mm from a neighboring third battery cell 110. The battery cells 110 in a common battery block 105 can be uniformly spaced, or evenly spaced. One or more battery cells 110 in a common battery block 105 can be spaced one or more different distances from another one or more battery cells 110 of the common battery block 105. Depending on the shape of each battery cell 110, the battery cells 110 can be arranged spatially relative to one another to reduce overall volume of the battery block 105, to allow for minimum cell to cell spacing (e.g., to ensure proper operation and meet specifications), or to allow for an adequate number of vent ports.

The battery cells 110 (e.g., adjacent battery cells 110) between different battery blocks 105 (e.g., adjacent battery blocks) can be spaced a distance in a range from 2 mm to 6 mm. For example, one or more battery cells 110 disposed along an edge of a first battery block 105 can be spaced a distance in a range from 0 mm to 1 mm (e.g., 0.5 mm) from the edge of the first battery block 105 and one or more battery cells 110 disposed along an edge of a second battery block 105 can be spaced a distance in a range from 0 mm to 1 mm (e.g., 0.5 mm) from the edge of the second battery block 105. The edges of the first and second battery blocks 105 can be coupled with each other, in contact with each other, or facing each other such that the one or more battery cells 110 disposed along the edge of the first battery block 105 are spaced from the one or more battery cells 110 disposed along the edge of the second battery block 105 a distance in a range from 2 mm to 6 mm (e.g., 4.5 mm). The distances between the battery cells 110 of different battery blocks 105 can vary and can be selected based at least in part on the dimensions of the battery blocks 105, electrical clearance or creepage specifications, or manufacturing tolerances for the respective battery module 100. For example, battery cells 110 can be spaced a distance from a second, different battery cell 110 based on predetermined manufacturing tolerances that may control or restrict how close battery cells 110 can be positioned with respect to each other.

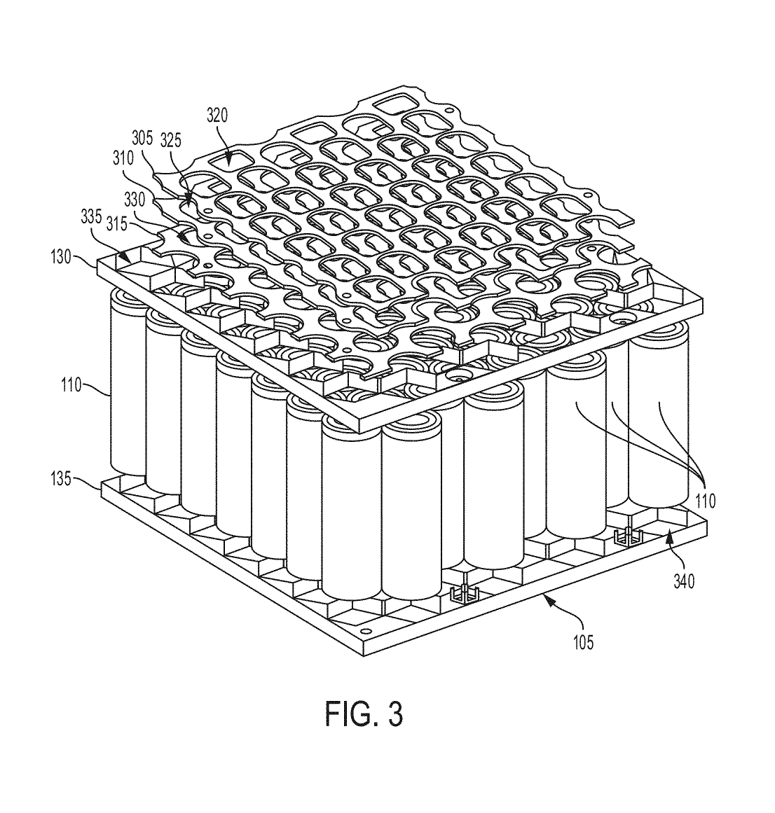

The battery cells 110 can each couple with a first layer (e.g., positive conductive layer) of the first cell holder 130. For example, the first cell holder 130 can include multiple layers, such as, a first layer forming a positive current collector (e.g., conductive positive layer 305 of FIG. 3), an isolation layer having non-conductive material, and a second layer forming negative current collector (e.g., conductive negative layer 315 of FIG. 3). Each of the battery cells 110 can include a pair of terminals 260, 265. For example, the battery cells 110 can include a positive terminal 260 and a negative terminal 265. The pair of terminals 260, 265 of each of the battery cells 110 can have up to 5V across their respective terminals. For example, the positive terminal 260 can be coupled with +5V and the negative terminal 265 can be coupled with 0V.

The positive terminal 260 can be coupled with +2.5V and the negative terminal 265 can be coupled with −2.5V. Thus, the difference in voltage between the positive terminal 260 and the negative terminal 265 of each battery cell 110 can be 5 v or in any value up to and including 5V.

The battery cells 110 can be coupled with a first layer (e.g., positive conductive layer) of the first cell holder 130 though a positive tab 210 (e.g., wirebond) and coupled with a second, different layer (e.g., negative conductive layer) of the first cell holder 130 through a negative tab 215. The positive terminal 260 of a battery cell 110 can be connected using the positive tab 210 or otherwise, with the first layer of the first cell holder 130. The negative terminal 265 or negative surface of a battery cell 110 can connect with the second layer of the first cell holder 130 through the negative tab 215. The positive terminal 260 and the negative terminal 265 of a battery cell 110 can be formed on or coupled with at least a portion of the same surface (or end) of the respective battery cell 110. For example, the positive terminal 260 can be formed on or coupled with a first surface (e.g., top surface, side surface, bottom surface) of the battery cell 110 and the negative terminal 265 of the battery cell 110 can be formed on or coupled with the same first surface. Thus, the connections to positive and negative bus-bars or current collectors can be made from the same surface (or end) of the battery cell 110 to simplify the installation and connection of the battery cell 110 within a battery block 105.

The negative tab 215 can couple at least two battery cells 110 with a conductive negative layer of the first cell holder 130. The negative tab 215 can be part of the conductive negative layer, for example formed as an extension or structural feature within a plane of the conductive negative layer, or partially extending beyond the plane. The negative tab 215 can include conductive material, such as but not limited to, metal (e.g., copper, aluminum), or a metallic alloy or material. The negative tab 215 can form or provide a contact point to couple a battery cell 110 to a negative current collector of the first cell holder 130. The negative tab 215 can couple with or contact a top portion or top surface (e.g., negative terminal 265) of the battery cell 110. The negative tab 215 can couple with or contact a side surface of a battery cell 110. The negative tab 215 can couple with or contact a bottom portion or bottom surface of a battery cell 110. The surface or portion of a battery cell 110 the negative tab 215 couples with or contacts can correspond to the placement of the first cell holder 130 relative to the battery cell 110.

The negative tab 215 can have a shape to couple with or contact surfaces of at least two battery cells 110. The negative tab 215 can be formed in a variety of different shapes and have a variety of different dimensions (e.g., conformed to the dimensions of the battery cells 110 and their relative positions). The shape of the negative tab 215 can include, but not limited to, rectangular, square, triangular, octagon, circular shape or form, or one or more combinations of rectangular, square, triangular, or circular shape or form. For example, the negative tab 215 can be formed having one or more sides (e.g., portions or edges) having a circular or curved shape or form to contact a surface of the battery cells and one or more sides having a straight or angled shape. The particular shape, form or dimensions of the negative tab 215 can be selected based at least in part on a shape, form or dimensions of the battery cells 110 or a shape, form or dimensions of the first cell holder 130. The shape and structure of the negative tab 215 can be formed in two or three dimensions. For example, one or more edges or portions of the negative tab 215 can be folded or formed into a shape or structure suitable for bonding to a negative terminal portion of a battery cell 110. For a two-dimensional negative tab 215 (e.g., a negative tab 215 with a thickness conformed with a thickness of the corresponding conductive negative layer), the negative tab 215 can include or be described with one or more parameters, such as length, a width, surface area, and radius of curvature. For a three-dimensional negative tab 215 (e.g., a negative tab 215 with at least a portion that does not conform with a thickness of the corresponding conductive negative layer), the negative tab 215 can include or be described with one or more parameters, including length, width, height (or depth, thickness), one or more surface areas, volume, and radius of curvature. The three-dimensional negative tab 215 can include a folded, curved or accentuated portion that provides a larger surface for a negative surface of a battery cell 110 to couple with or contact. For example, the three-dimensional negative tab 215 can have a greater thickness than a two-dimensional negative tab 215.

The positive tab 210 can be a positive wirebond that can couple at least one battery cell 110 with a conductive positive layer of the cell holder 130. The positive tab 210 can be formed in a variety of different shapes and have a variety of different dimensions. The particular shape or dimensions of positive tab 210 can be selected based at least in part on a shape or a dimension of the battery cells 110 or a shape or a dimension of the first cell holder 130. For example, the positive tab 210 can be sized to extend from a top surface, side surface or bottom surface of a battery cell 110. As depicted in FIG. 2, the positive tab 210 can extend from a top surface (e.g., a positive terminal 260) of a battery cell 110 and extend through apertures formed in each of the different layers forming the first cell holder 130, to contact a top surface of the conductive positive layer of the cell holder 130. The shape of the positive tab 210 can be selected or implemented so as not to contact a negative layer of the first cell holder 130 as the positive tab 210 extends through the different layers forming the first cell holder 130. The shape or form of the positive tab 210 can include a rectangular shape, cylindrical shape, tubular shape, spherical shape, ribbon or tape shape, curved shape, flexible or winding shape, or elongated shape. The positive tab 210 can include electrical conductive material, such as but not limited to, copper, aluminum, metal, or metallic alloy or material.

FIG. 3, among others, provides an exploded view of an example battery block 105. The first cell holder 130 or the second cell holder 135 can include a plurality of layers (e.g., conductive layers, non-conductive layers) that couple the plurality of battery cells 110 with each other. Each of the first cell holder 130 and the second cell holder 135 can include alternating or interleaving layers of conductive layers and non-conductive layers. For example, each of the first cell holder 130 and the second cell holder 135 may include a positive conductive layer, an isolation layer having a non-conductive material, and a negative conductive layer.

FIG. 3 includes an example view of different layers of the first cell holder 130. In particular, FIG. 3 shows a second surface (e.g., bottom surface) of a first conductive layer 305 disposed over, coupled with, or in contact with a first surface (e.g., top surface) of a non-conductive layer 310. A second surface (e.g., bottom surface) of the non-conductive layer 310 is disposed over, coupled with, or in contact with a first surface (e.g., top surface) of a second conductive layer 315. A second surface (e.g., bottom surface) of the second conductive layer is disposed over, coupled with, or in contact with a first surface (e.g., top surface) of the first cell holder 130.

The first cell holder 130 can hold, house or align the first conductive layer 305, the non-conductive layer 310, and the second conductive layer 315. For example, the first cell holder 130 can include a border or raised edge formed around a border of the first cell holder 130 such that the first conductive layer 305, the non-conductive layer 310, and the second conductive layer 315 can be disposed within the border or raised edge. The border or raised edge formed around a border of the first cell holder 130 can hold the first conductive layer 305, the non-conductive layer 310, and the second conductive layer 315 in place and in physical contact with each other.

The first conductive layer 305, the non-conductive layer 310, the second conductive layer 315, the first cell holder 130, and the second cell holder 135 can include a plurality of apertures 320. The number of apertures 320 can be selected based in part on the size and dimensions of the first conductive layer 305, the non-conductive layer 310, the second conductive layer 315, the first cell holder 130, the second cell holder 135, and the battery cells 110. For example, the first conductive layer 305 can include a first plurality of apertures 320 having a first shape. The non-conductive layer 310 can include a second plurality of apertures 325 having a second shape. The second conductive layer 315 can include a third plurality of apertures 330 having a third shape. The first cell holder 130 can include a fourth plurality of apertures 335 having a fourth shape. The second cell holder 135 can include a fourth plurality of apertures 340 having a fifth shape. The apertures 320, 325, 330, 335, 340 can include an opening or hole formed through each of the respective layers, or a recess formed into the respective layers or structures.

The shape, dimensions, or geometry of one or more of the first plurality of apertures 320, the second plurality of apertures 325, the third plurality of apertures 330, the fourth plurality of apertures 335, and the fifth plurality of apertures 340 can be different. The shape, dimensions, or geometry of one or more of the first plurality of apertures 320, the second plurality of apertures 325, the third plurality of apertures 330, the fourth plurality of apertures 335, and the fifth plurality of apertures 340 can be the same or similar. The shape, dimensions, or geometry of the apertures 320, 325, 330, 335, 340 can be selected according to an arrangement or separation of the battery cells 110. Two or more of the first, second, third, fourth and fifth shapes can be conformed at least in part relative to one other. Two or more of the first, second, third, fourth and fifth pluralities of apertures can be aligned relative to one other. The shape, dimensions, or geometry of the apertures 320, 325, 330, 335, 340 can be determined based at least in part on the shape, dimensions, or geometry of the battery cells 110. For example, the plurality of battery cells 110 can be disposed or positioned between a second surface (e.g., bottom surface) of the first cell holder 130 and a first surface (e.g., top surface) of the second cell holder 135. The first cell holder 130 or the second cell holder 135 can hold, house or align the plurality of battery cells 110 using the fourth plurality of apertures 335 or the fifth plurality of apertures 340, respectively. For example, each of the battery cells 110 can be disposed within the battery block 105 such that a bottom end or bottom portion of a battery cell 110 is disposed in, coupled with or on contact with at least (an edge, boundary, side, surface or structure of) one aperture of the fifth plurality of apertures 340 formed in the second cell holder 135, and a top end or top portion of a battery cell 110 is disposed in, coupled with or on contact with at least (an edge, boundary, side, surface or structure of) one aperture of the fourth plurality of apertures 335 formed in the first cell holder 130.

The apertures 320, 325, 330 of the first conductive layer 305, the non-conductive layer 310, and the second conductive layer 315 can allow a connection to a positive layer (e.g., first conductive layer 305) or negative layer (e.g., second conductive layer 315) from each of the battery cells 110. For example, a wirebond 210 can extend through the apertures 320, 325, 330 to couple a positive terminal or surface of a battery cell with the first conductive layer 305. Thus, the apertures 320, 325, 330 can be sized to have a diameter or opening that is greater than a diameter or cross-sectional shape of the wirebond 210. A negative tab 215 can extend from the second conductive layer 315 and be connected to negative surfaces or terminals on at least two battery cells 110. For example, a wirebond can extend from the negative tab 215 to couple with a portion of a negative terminal on a battery cell 110 that is exposed by the aperture 330. Thus, one or more of the apertures 320, 325, 330 can be sized to have dimensions that are greater than the dimensions of the negative tab 215, or greater than a diameter or cross-sectional shape of the wirebond. The shape of the apertures 320, 325, 330, 335, 340 can include a round, rectangular, square, or octagon shape or form as some examples. The dimensions of the apertures 320, 325, 330, 335, 340 can include a width of 21 mm or less for instance. The dimensions of one or more of the apertures 320, 325, 330, 335, 340 can be 12 mm in width and 30 mm in length for example.

The apertures 320, 325, 330 can be formed such that they are smaller than the apertures 335, 340. For example, the apertures 335 and 340 can have a diameter in a range from 10 mm to 35 mm (e.g., 18 mm to 22 mm). The apertures 320, 325, 330 can have a diameter in a range from 3 mm to 33 mm. If the apertures 335, 340 are formed having a square or rectangular shape, the apertures 335, 340 can have a length in a range from 4 mm to 25 mm (e.g., 10 mm). If the apertures 335, 340 are formed having a square or rectangular shape, the apertures 335, 340 can have a width in a range from 4 mm to 25 mm (e.g., 10 mm). For example, the apertures 335, 340 can have dimensions of 10 mm×10 mm. If the apertures 320, 325, 330 are formed having a square or rectangular shape, the apertures 320, 325, 330 can have a length in a range from 2 mm to 20 mm (e.g., 7 mm). If the apertures 320, 325, 330 are formed having a square or rectangular shape, the apertures 320, 325, 330 can have a width in a range from 2 mm to 20 mm (e.g., 7 mm). For example, the apertures 320, 325, 330 can have dimensions of 7 mm×7 mm.

Apertures 325 can be formed such that they are smaller (e.g., have smaller dimensions) or offset with respect to apertures 320. For example, apertures 325 can correspond to apertures 320, such as having the same geometric shape with just an offset to make the apertures 325 smaller with respect to apertures 320. For example, the offset can be in a range from 0.1 mm to 6 mm depending on isolation, creepage, and clearance requirements. Apertures 325 can be sized the same as or identical to aperture 320.

The apertures 320, 325, 330 can be formed in a variety of shapes. For example, the apertures 320, 325, 330 may not be formed as distinct patterned openings or formed having distinct patterned openings. For example, the apertures 320, 325, 330 can be formed as a geometric cut from the sides of the respective one of layers 305, 310, 315. The apertures 320, 325, 330 can be formed as half circular cutouts around the perimeter of each of the respective one of layers 305, 310, 315, respectively.

The first conductive layer 305 and the second conductive layer 315 can include a conductive material, a metal (e.g., copper, aluminum), or a metallic material. The first conductive layer 305 can be a positive conductive layer or positively charged layer. The second conductive layer 315 can be a negative conductive layer or negatively charged layer. The first conductive layer 305 and the second conductive layer 315 can have a thickness in a range of 1 to 8 millimeters (e.g., 1.5 mm). The first conductive layer 305 and the second conductive layer 315 can have the same length as battery block 105. The first conductive layer 305 and the second conductive layer 315 can have the same width as battery block 105.

The non-conductive layer 310 can include insulation material, plastic material, epoxy material, FR-4 material, polypropylene materials, or formex materials. The non-conductive layer 310 can hold or bind the first conductive layer 305 and the second conductive layer 315 together. The non-conductive layer 310 can include or use adhesive(s) or other binding material(s) or mechanism(s) to hold or bind the first conductive layer 305 and the second conductive layer 315 together. The non-conductive layer 310, the first conductive layer 305, and the second conductive layer 315 can be held or bound together to form a multi-layer composite, sometimes collectively referred as a multi-layered current collector. The dimensions or geometry of the non-conductive layer 310 can be selected to provide a predetermined creepage, clearance or spacing (sometimes referred to as creepage-clearance specification or requirement) between the first conductive layer 305 and the second conductive layer 315. For example, a thickness or width of the non-conductive layer 310 can be selected such that the first conductive layer 305 is spaced at least 3 mm from the second conductive layer 315 when the non-conductive layer 310 is disposed between the first conductive layer 305 and the second conductive layer 315. The non-conductive layer 310 can be formed having a shape or geometry that provides the predetermined creepage, clearance or spacing. For example, the non-conductive layer 310 can have a different dimension than that the first conductive layer 305 and the second conductive layer 315, such that an end or edge portion of the non-conductive layer 310 extends out farther (e.g., longer) than an end or edge portion of the first conductive layer 305 and the second conductive layer 315 relative to a horizontal plane or a vertical plane. The distance that an end or edge portion of the non-conductive layer 310 extends out can provide the predetermined creepage, clearance or spacing (e.g., 3 mm creepage or clearance). The thickness and insulating structure of the non-conductive layer 310 that separate the first conductive layer 305 and the second conductive layer 315 can provide the predetermined creepage, clearance or spacing. The thickness and insulating structure of the non-conductive layer 310, that separate the first conductive layer 305 from the second conductive layer 315, can provide the predetermined creepage, clearance or spacing. Thus, the dimensions of the non-conductive layer 310 can be selected, based in part, to meet creepage-clearance specifications or requirements. The dimensions of the non-conductive layer 310 can reduce or eliminate arcing between the first conductive layer 305 and the second conductive layer 315. The non-conductive layer 310 can have a thickness that ranges from 0.1 mm to 8 mm (e.g., 1 mm). The non-conductive layer 310 can have the same width as the battery block 105. For example, the non-conductive layer 310 can have a width in a range from 25 mm to 700 mm (e.g., 330 mm). The non-conductive layer 310 can have the same length as the battery block 105. For example, the non-conductive layer 310 can have a length in a range from 25 mm to 700 mm (e.g., 150 mm).

The first cell holder 130 and the second cell holder 135 can include plastic material, acrylonitrile butadiene styrene (ABS) material, polycarbonate material, or nylon material (e.g., PA66 nylon) with glass fill for instance. The rigidity of first cell holder 130 and the second cell holder 135 can correspond to the material properties forming the respective first cell holder 130 and the second cell holder 135, such as flexural modulus. The first cell holder 130 and the second cell holder 135 can have a dielectric strength of 300V/mil for instance (other values or ranges of the values are possible). The first cell holder 130 and the second cell holder 135 can for example have a tensile strength of 9,000 psi (other values or ranges of the values are possible. The first cell holder 130 and the second cell holder 135 can have a flexural modulus (e.g., stiffness/flexibility) of 400,000 psi (other values or ranges of the values are possible). The values for the dielectric strength, tensile strength, or flexural modulus can vary outside these values or range of values and can be selected based in part on a particular application of the first cell holder 130 and the second cell holder 135. The first cell holder 130 and the second cell holder 135 can have a flame resistance rating (e.g., FR rating) of UL 94 rating of V-0 or greater. The first cell holder 130 or the second cell holder 135 can have a UL 94 (e.g., plastics flammability of plastic materials) rating of V-0 that corresponds to a thickness of a wall portion of the respective layer. For example, the thinner a wall thickness is the more difficult it can be to achieve a V-0 rating. Thus, the first cell holder 130 or the second cell holder 135 can have a thickness between 0.5 mm to 2.5 mm.

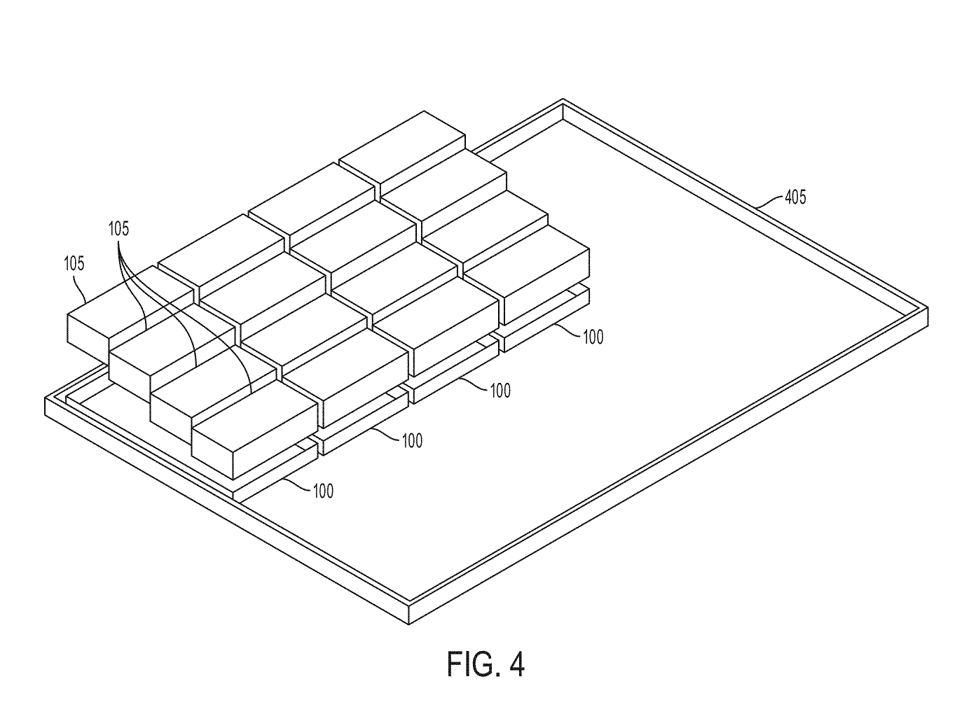

Now referring to FIG. 4, among others, a battery pack 405 is depicted having a plurality of battery modules 100, with each of the battery modules 100 having a plurality of battery blocks 105. The battery blocks 105 may include a plurality of battery cells 110. A battery pack 405 as described herein can refer to a battery system having multiple battery modules 100 (e.g., two or more). Multiple battery modules 100 can be electrically coupled with each other to form a battery pack 405, using one or more electrical connectors such as bus-bars. For example, four (or other number of) battery blocks 105 can be connected using ribbonbond interconnects 205 and arranged to form a battery module 100, and multiple battery modules 100 can be connected (e.g., using ribbonbond interconnects 205) and arranged to form the battery pack 405 for a given application. Each battery module 100 can include a physical structure or holder to support, hold or partially enclose the corresponding submodules or battery blocks 105.

The ribbonbond interconnects 205 can be used in the battery pack 405 to couple multiple battery blocks 105 with each other, and can be used to couple multiple battery modules 100 with each other. For example, the ribbons bond interconnects 205 can be formed having predetermined lengths and electrical and mechanical specification to fit a particular application of the battery pack 405, such as but not limited to particular number of battery blocks 105 or battery modules 100. The ribbonbond interconnects 205 can have various dimensions (e.g., length, thickness, cross-sectional area) or materials, for example, for different battery pack 405 assemblies. Different battery pack 405 assemblies can use the ribbonbond interconnects 205 in various ways (e.g., welded, wire-bonded, bolted), using various numbers of ribbonbond interconnects 205 for parallel/alternative electrical pathways, using various connection angles relative to battery blocks 105 or current collector edges, or allowing for various levels of movement or maximum current flow between battery blocks 105. For example, the number of ribbonbond interconnects 205 between multiple battery blocks 105 (e.g., between two battery blocks 105, between more than two battery blocks 105), the orientation(s) of the ribbonbond interconnects 205, or how closely they are located together, can be adjusted to achieve various characteristics.

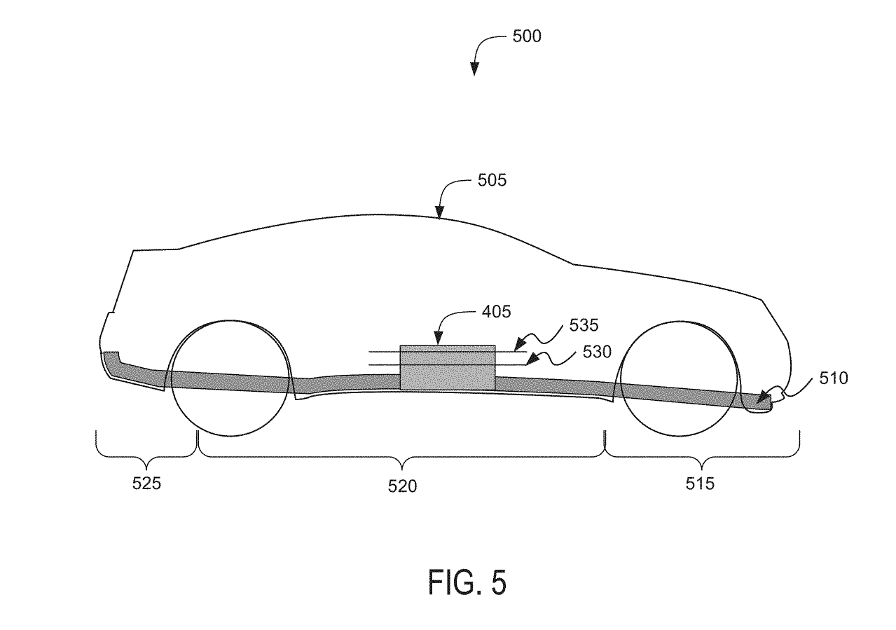

The battery blocks 105 can be electrically coupled or connected to one or more other battery blocks 105 to form a battery module 100 or battery pack 405 of a specified capacity and voltage. The number of battery blocks 105 in a single battery module 100 can vary and can be selected based at least in part on a desired capacity of the respective battery module 100. The number of battery modules 100 in a single battery pack 405 can vary and can be selected based at least in part on a desired capacity of the respective battery pack 405. For example, the number of battery modules 100 in a battery pack 405 can vary and can be selected based at least in part on an amount of energy to be provided to an electric vehicle. The battery pack 405 can couple or connect with one or more bus-bars of a drive train system of an electric vehicle to provide electrical power to other electrical components of the electric vehicle (e.g., as depicted in FIG. 5).

The battery blocks 105 and the battery modules 100 can be combinable with one or more other battery blocks 105 and battery modules 100 to form the battery pack 405 of a specified capacity and a specified voltage that is greater than that across the terminals of the battery block 105 or battery module 100. For instance, a high-torque motor may be suitably powered by a battery pack 405 formed with multiple battery cells (e.g., 500 cells), blocks 105 or modules 100 connected in parallel to increase capacity and to increase current values (e.g., in Amperes or amps) that can be discharged. A battery block 105 can be formed with 20 to 50 battery cells 110 for instance, and can provide a corresponding number of times the capacity of a single battery cell 110. A battery pack 405 formed using at least some battery blocks 105 or battery modules 100 connected in parallel can provide a voltage that is greater than that across the terminals of each battery block 105 or battery module 100. A battery pack 405 can include any number of battery cells 110 by including various configurations of battery blocks 105 and battery modules 100.

The battery module 100 or battery pack 405 having one or more battery blocks 105 can provide flexibility in the design of the battery module 100 or the battery pack 405 with initially unknown space constraints and changing performance targets. For example, standardizing and using small battery blocks 105 can decrease the number of parts (e.g., as compared with using individual cells) which can decrease costs for manufacturing and assembly. The battery modules 100 or battery packs 405 having one or more battery blocks 105 as disclosed herein can provide a physically smaller, modular, stable, high capacity or high power device that is not available in today's market, and can be an ideal power source that can be packaged into various applications.

The shape and dimensions of the battery pack 405 can be selected to accommodate installation within an electric vehicle. For example, the battery pack 405 can be shaped and sized to couple with one or more bus-bars of a drive train system (which includes at least part of an electrical system) of an electric vehicle. The battery pack 405 can have a rectangular shape, square shape, or a circular shape, among other possible shapes or forms. The battery pack 405 (e.g., an enclosure or outer casing of the battery pack 405) can shaped to hold or position the battery modules 100 within a drive train system of an electric vehicle. For example, the battery pack 405 can be formed having a tray like shape and can include a raised edge or border region. Multiple battery modules 100 can be disposed within the battery pack 405 can be held in position by the raised edge or border region of the battery pack 405. The battery pack 405 may couple with or contact a bottom surface or a top surface of the battery modules 100. The battery pack 405 can include a plurality of connectors to couple the battery modules 100 together within the battery pack 405. The connections may include, but not limited to, straps, wires, adhesive materials, or fasteners.

The battery blocks 105 can be coupled with each other to form a battery module 100 and multiple battery modules 100 can be coupled with each other to form a battery pack 405. The number of battery blocks 105 in a single battery module 100 can vary and be selected based at least in part on a desired capacity or voltage of the respective battery module 100. The number of battery modules 100 in a single battery pack 405 can vary and be selected based at least in part on a desired capacity of the respective battery pack 405. For instance, a high-torque motor may be suitably powered by a battery pack 405 having multiple battery modules 100, the battery modules 100 having multiple battery blocks 105 and the battery blocks 105 having multiple battery cells 110. Thus, a battery pack 405 can be formed with a total number of battery cells ranging from 400 to 600 (e.g., 500 battery cells 110), with the battery blocks 105 or battery modules 100 connected in parallel to increase capacity and to increase current values (e.g., in Amperes or amps) that can be discharged. A battery block 105 can be formed with any number of battery cells 110 and can provide a corresponding number of times the capacity of a single battery cell 110.

For example, a single battery block 105 can include a fixed number of battery cells 110 wired in parallel (“p” count) and have the same voltage with that of the battery cell 110, and “p” times the discharge amps. A single battery block 105 can be wired in parallel with one or more battery blocks 105 to make a larger “p” battery block 105 for higher current applications, or wired in series as a module/unit to increase voltage. Additionally, a battery block 105 can be packaged into varying applications and can be adapted to meet various standard battery sizes as defined by regulating bodies (e.g., Society of Automotive Engineers (SAE), United Nations Economic Commission for Europe (UNECE), German Institute for Standardization (DIN)) for different industries, countries, or applications.

A battery block 105 that is standardized or modularized into a building block or unit, can be combined or arranged with other battery blocks 105 to form a battery module 100 (or battery pack 405) that can power any device or application, e.g., PHEV, REV, EV, automotive, low voltage 12 volt system, 24 volt system, or 48 volt system, 400 volt system, 800 volt system, 1 kilovolt system, motorcycle/small light duty applications, enterprise (e.g., large or commercial) energy storage solutions, or residential (e.g., small or home) storage solutions, among others.

In accordance with the concepts disclosed herein, battery components are standardized or modularized at the battery block level rather than at the battery module level. For example, each of the battery cells 110 can be formed having the same shape and dimensions. Each of the battery blocks 105 can be formed having the same shape and dimensions. Each of the battery modules 100 can be formed having the same or different shape and dimensions. Thus, battery cells 110 can be individually replaced or additional battery cells 110 can be added to increase the capacity of the respective battery block 105. Battery blocks 105 can be individually replaced or additional battery blocks 105 can be added to increase the capacity of the respective battery module 100. For example, the plurality battery modules can have a battery module capacity that are greater than the battery block capacity. Each of the plurality of battery modules can have a battery module voltage greater than the voltage across the battery block terminals of the first battery block. Battery modules 100 can be individually replaced or additional battery modules 100 can be added to increase the capacity of the respective battery pack 405. In some applications or embodiments, standardization or modularization at the battery module level can be implemented instead of, or in addition to that at the battery block level.

For example, consider the above example of a 5V/300 Ah battery block. For comparative purposes, current single battery cells of 5V/50 Ah technologies can be 0.03 cubic feet and six of these single cell batteries connected in parallel would make this 0.18 cubic feet in size. This is multiple times larger than a corresponding battery block disclosed herein (e.g., 0.05 cubic feet). Thus, other single cell technologies offer no volumetric advantage, and instead provide an increased hazard or failure risk.

The battery modules 100 or battery block 105 disclosed herein can overcome packaging constraints, and can meet various performance targets using the same voltage of each component battery cell (0-5V) but with “p” times the discharge amps (e.g., discharge amps multiplied by the number of cells connected in parallel in the battery block). The battery modules 100 or battery block 105 can be formed into battery packs 405 of various size, power and energy to meet different product performance requirements with the best packing efficiency and volumetric energy density that matches a specific design.

A battery block 105 can allow flexibility in the design of a battery module or a battery pack 405 with initially unknown space constraints and changing performance targets. Standardizing and using battery blocks (which are each smaller in size than a battery module) can decrease the number of parts (e.g., as compared with using individual cells) which can decrease costs for manufacturing and assembly. A standardized battery module, on the other hand, can limit the types of applications it can support due to its comparatively larger size and higher voltage. Standardizing battery modules 100 with nonstandard blocks 105 can increase the number of parts which can increase costs for manufacturing and assembly. In comparison, a battery block 105 as disclosed herein can provide a modular, stable, high capacity or high power device, such as a battery module 100 or battery pack 405, that is not available in today's market, and can be an ideal power source that can be packaged into various applications.

FIG. 5 depicts a cross-section view 500 of an electric vehicle 505 installed with a battery pack 405. The battery pack 405 can include a battery module 100 having a plurality of battery blocks 105. The battery blocks 105 can be electrically coupled through one or more interconnects 205 to power the electric vehicle 505. The electric vehicle 505 can include an autonomous, semi-autonomous, or non-autonomous human operated vehicle. The electric vehicle 505 can include a hybrid vehicle that operates from on-board electric sources and from gasoline or other power sources. The electric vehicle 505 can include automobiles, cars, trucks, passenger vehicles, industrial vehicles, motorcycles, and other transport vehicles. The electric vehicle 505 can include a chassis 510 (sometimes referred to herein as a frame, internal frame, or support structure). The chassis 510 can support various components of the electric vehicle 505. The chassis 510 can span a front portion 515 (sometimes referred to herein a hood or bonnet portion), a body portion 520, and a rear portion 525 (sometimes referred to herein as a trunk portion) of the electric vehicle 505. The front portion 515 can include the portion of the electric vehicle 505 from the front bumper to the front wheel well of the electric vehicle 505. The body portion 520 can include the portion of the electric vehicle 505 from the front wheel well to the back wheel well of the electric vehicle 505. The rear portion 525 can include the portion of the electric vehicle 505 from the back wheel well to the back bumper of the electric vehicle 505.

The battery pack 405 that includes a battery module 100 having a plurality of battery blocks 105 with each of the battery blocks 105 electrically coupled through one or more interconnects 205 can be installed or placed within the electric vehicle 505. For example, the battery pack 405 can couple with a drive train unit of the electric vehicle 505. The drive train unit may include components of the electric vehicle 505 that generate or provide power to drive the wheels or move the electric vehicle 505. The drive train unit can be a component of an electric vehicle drive system. The electric vehicle drive system can transmit or provide power to different components of the electric vehicle 505. For example, the electric vehicle drive train system can transmit power from the battery pack 405 to an axle or wheels of the electric vehicle 505. The battery pack 405 can be installed on the chassis 510 of the electric vehicle 505 within the front portion 515, the body portion 520 (as depicted in FIG. 5), or the rear portion 525. A first bus-bar 535 and a second bus-bar 530 can be connected or otherwise be electrically coupled with other electrical components of the electric vehicle 505 to provide electrical power from the battery pack 405 to the other electrical components of the electric vehicle 505.

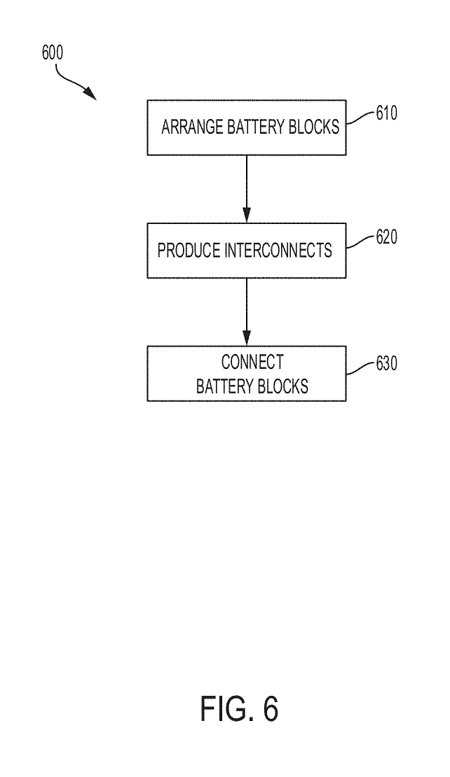

FIG. 6, among others, depicts an example embodiment of a method 600 for interconnecting battery blocks 105 is depicted. The method 600 can include arranging a battery block (ACT 610). For example, a first battery block 105 and a second battery block 105 (of a plurality of battery blocks 105 can be arranged relative to each other. Each battery block 105 may include a plurality of battery cells 110 electrically connected and physically arranged to form a battery module 100 (or battery pack 405) for storing energy. A battery block 105 can correspond to a standardized or modularized building block or unit, and can be combined or arranged with other battery blocks 105 to form a battery module 100 (or battery pack 405) that can power any device or application, such as but not limited to drive units to provide power for electric vehicle systems.

A first battery block 105 can be arranged or positioned relative to a second battery block 105 to be electrical connected and to form a battery module 100. The number of battery blocks 105 arranged or positioned relative to each other can vary and can be selected based at least in part on a desired capacity of a battery module 100 or battery pack 405. The battery blocks 105 can be arranged in a variety of different formations or arrangements. For example, the battery blocks 105 can be arranged in rows and columns to form a square or rectangular battery module 100. The particular arrangements of the battery blocks 105 can be selected based at least in part on an application of the battery module 100 and the dimensions or size constraints correspond to that application of the battery module 100.

The method 600 can include producing a plurality of ribbonbond interconnects 205 (ACT 620). For example, a first plurality of ribbonbond interconnects 205 consistent with the arrangement of battery block 105 can be produced. The first or additional plurality of ribbonbond interconnects 205 can be produced consistent with the arrangement of the battery blocks 105, and according a set of specifications (e.g., a predefined threshold for electrical current flow). For example, each of the first plurality of ribbonbond interconnects 205 can have or be produced to have a threshold for electrical current flow. The ribbonbond interconnects 205 can make an electrical connection between at least two different battery blocks 105 and carry current between the respective battery blocks 105. The threshold can correspond to the current to be carried between the battery blocks 105.

The ribbonbond interconnects 205 can be designed or formed having a maximum current carrying threshold or capability such that the ribbonbond interconnects 205 can break or otherwise disconnect the electrical connection between the respective battery blocks 105 when the current flowing through the respective ribbonbond interconnect 205 reaches or exceeds the maximum current carrying threshold or capability of the respective ribbonbond interconnect 205. The ribbonbond interconnects 205 maximum current carrying threshold or capability can be predetermined, selected, designed, or implemented to break (e.g., disconnect, burn out, disintegrate, or otherwise provide an open circuit connection) under predefined (e.g., unwanted) high current condition(s). A high current condition can vary and the particular amount of a high current condition can be based at least in part on a particular application of the battery blocks 105, a battery module 100, or a battery pack 405. Such predefined high current condition(s) can be specified for continuous current, instantaneous current, average current, etc., in various embodiments.

The method 600 can include electrically connecting battery blocks 105 (ACT 630). For example, the first battery block 105 can be electrically coupled or connected with second battery block 105 using the first plurality of ribbonbond interconnects 205. The first plurality of ribbonbond interconnects 205 can electrically couple the first battery block 105 with the second battery block 105. The first battery block 105 can be electrically coupled with or connected with second battery block 105 using one or more of the plurality of ribbonbond interconnects 205. Each ribbonbond interconnect 205 can include or be formed from a metallic strip that can provide a flexible physical connection between the first battery block 105 and the second battery block 105.

Each ribbonbond interconnect 205 can break an electrical connection between the first battery block 105 and the second battery block 105 if an electrical current in the corresponding ribbonbond interconnect 205 exceeds the predetermined threshold. The predetermined threshold can correspond to the respective ribbonbond interconnects 205 maximum current carrying threshold or capability. The predetermined threshold can vary and be based in part on a particular application of the battery blocks 105, a battery module 100, or a battery pack 405. The predetermined threshold can be lower than the respective ribbonbond interconnects 205 maximum current carrying threshold or capability or lower than that for breaking an electrical connection between a terminal of one of the plurality of battery cells and a first current collector of the first battery block 105 or a second current collector of the second battery block 105.

A first ribbonbond interconnect 205 of the plurality of ribbonbond interconnects 205 can be produced to have a physical length to allow up to a predefined level of movement between the first battery block 105 and the second battery block 105 while physically coupling or connecting the first battery block 105 with the second battery block 105. The length or predefined level of movement can be selected based in part on a particular application of the battery blocks 105, a battery module 100, or a battery pack 405. For example, the length or predefined level of movement of one or more ribbonbond interconnects 205 can be selected to allow respective battery blocks 105 to move in an x-direction, y-direction, or z-direction while the battery blocks 105 are disposed within a drive unit of an electric vehicle during operation of the electric vehicle, while the one or more ribbonbond interconnects 205 maintain an electrical connection between the respective battery blocks 105.

A first portion of a first ribbonbond interconnect 205 of the plurality of ribbonbond interconnects 205 can be welded or bonded to a portion of the first battery block 105, and a second portion of the first ribbonbond interconnect 205 can be welded or bonded to a portion of the second battery block 105. The portion of the first battery block 105 and the portion of the second battery block 105 can be offset in position by at least a predetermined distance along edges of the first battery block 105 and the second battery block 105 that are closest to the welded or bonded first ribbonbond interconnect 205. In some cases, an offset allows for selection of welding points with sufficient surface area for proper welding or improved electrical conductivity. An offset in position, or a corresponding ribbonbond interconnect 205 that is implemented at a non-perpendicular angle relative to the battery block edges, can provide improved control of the level of movement between battery blocks 105, improved resistance or resilience against physical failure, or improved current density/flow, e.g., relative to zero offset or a perpendicular angle. Different offsets or connection angles can be applied to different ones of a plurality of ribbonbond interconnects 205 between two battery blocks 105, in order to achieve desired characteristics such as those described herein.

The ribbonbond interconnects 205 can be coated or electroplated with a coating material or coating layer that is a different material than the material of the ribbonbond interconnects 205. For example, the ribbonbond interconnects 205 can be coated or electroplated with a metallic material, such as but not limited to nickel. The coating material or coating layer can for instance add strength, resilience against physical failure (e.g., at the welding or bonding points), or alter conductivity characteristics of the respective ribbonbond interconnect 205.

A battery block 105 (or multiple battery blocks 105, e.g., held in a configuration) can be assembled or prepared for assembly. The battery block 105 can be prepared for ribbon bonding (e.g., applying ribbonbond interconnects 205). The battery block 105 can be provided to or sent to a ribbon bond station where the battery block 105 is inserted into a ribbon bond machine. The ribbon bond station can be programmed to couple, dispose, draw or connect one or more ribbonbond interconnects 205 (e.g., metallic strip ribbons) having a predetermined length, electrical specifications, and mechanical specifications to the battery block 105. The one or more ribbonbond interconnects 205 can be coupled, disposed, drawn or connected to one or more locations or surfaces of the battery block 105, with the locations or surfaces selected based at least in part on a particular application of the battery block 105. The ribbonbond interconnects 205 can be modified, such as but not limited to, trimmed, cut, machines, sliced or sized to a particular length (e.g., a length necessary to couple with a second, different battery block 105). If a rework is requested or needed, the ribbonbond interconnects 205 can be removed and the battery block 105 can be provided to or sent back into the ribbon bond station machine to be bonded according to another set of specifications if appropriate.

The ribbonbond interconnects 205 can couple a plurality of battery blocks 105 in series and form a current path 230 having a predetermined shape. For example, the current path 230 can correspond to the flow of current from one battery block 105 to a second, different battery block 105 in a plurality of battery blocks 105. A plurality of electrical pathways or a plurality of current paths 230 can be formed from a first current collector (e.g., positive current collector, negative current collector) of the first battery block 105 to a second current collector (e.g., positive current collector, negative current collector) of the second battery block 105 using the first plurality of ribbonbond interconnects 205. The plurality of electrical pathways or the plurality of current paths 230 can have the same shape or one or more can have different shapes.

The shape of the current path 230 can vary and be formed based at least in part on the arrangement of the battery blocks 105. The current path 230 can be formed having a “U” shape and the battery blocks 105 can be arranged into a square or rectangular shape or footprint. Thus, the first battery block 105 is coupled with the second battery block 105, the second battery block 105 is coupled with the third battery block 105, and the third battery block 105 is coupled with the fourth battery block 105, each using a corresponding plurality of ribbonbond interconnects 205, in a current path 230 having the “U” shape. However, if the battery blocks 105 were arranged in a straight line, the current path 230 could be formed in a straight line. For example, a second plurality of ribbonbond interconnects 205 can electrically connect a current collector of a third battery block 105 with a current collector of a fourth battery block 105. The number of ribbonbond interconnects 205 used to couple multiple battery blocks 105 with each other can vary and be selected based in part on the number of battery blocks 105 or a current level to be transferred between the different battery blocks 105.

The ribbonbond interconnects 205 can be coupled to various edges, surfaces, or portions of the battery blocks 105 or current conductors of the battery blocks 105. For example, a first ribbonbond interconnect 205 of the first plurality of ribbonbond interconnects 205 can be coupled with edges of the first battery block 105 and the second battery block 105 at other than a perpendicular angle relative to the edges of the first battery block 105 and the second battery block 105. A first ribbonbond interconnect 205 of the first plurality of ribbonbond interconnects 205 can be coupled with edges of the first battery block 105 and the second battery block 105 at a first angle relative to the edges and a second ribbonbond interconnect 205 of the first plurality of ribbonbond interconnects 205 can be coupled with the edges at a second angle relative to the edges.

The ribbonbond interconnects 205 applied to battery blocks 105 can accomplish at least one of: overcome shearing and breaking that is an issue with rigid connections; provide improved heat dissipation and correspondingly improved performance for continuous high current applications (e.g., above 40 A, although other values are possible); provide a small footprint which can be easier for rework and allow redundant bonds in the same area (e.g., a footprint smaller than bus bar connections); and act as a fuse for protection against overcurrent (e.g., that is greater than 50 A or other predetermined threshold).

The amperage or size of the fuse formed or created by the plurality of ribbonbond interconnects 205 can correspond to the properties of the plurality of ribbonbond interconnects 205 used to couple the different battery blocks 105. For example, the dimensions, size, length, or number of ribbonbond interconnects 205 can be selected to form or create a fuse of one or more ribbonbond interconnects 205 electrically coupling at least two battery blocks 105. The number of ribbonbond interconnects 205 electrically coupling at least two battery blocks 105 can be varied to form or create a fuse of a predetermined size, the dimensions of one or more ribbonbond interconnects 205 electrically coupling at least two battery blocks 105 can be varied to form or create a fuse of a predetermined size, the length of one or more ribbonbond interconnects 205 electrically coupling at least two battery blocks 105 can be varied to form or create a fuse of a predetermined size, or the width or one or more ribbonbond interconnects 205 electrically coupling at least two battery blocks 105 can be varied to form or create a fuse of a predetermined size.

The amperage or size of the fuse formed or created by the plurality of ribbonbond interconnects 205 can vary and can be selected based at least in part on a particular application of the battery blocks 105, the battery module 100 or a battery pack 405. The amperage or size of the fuse formed or created by the plurality of ribbonbond interconnects 205 can be in a range from 80 Amps to 120 Amps, inclusive per ribbonbond interconnect (e.g., 100 Amps). The fusing for the ribbonbond interconnects 205 can range from 40 Amps to 250 Amps.

The ribbonbond interconnects 205 can be disposed or coupled between the battery blocks 105 such that they are evenly spaced across respective surfaces of the battery blocks 105 or evenly spaced across respective surfaces of current conductors of the battery blocks 105. The ribbonbond interconnects 205 can be disposed or coupled between the battery blocks 105 such that they are randomly or unevenly spaced across respective surfaces of the battery blocks 105 or randomly or unevenly spaced across respective surfaces of current conductors of the battery blocks 105. The ribbonbond interconnects 205 can be used to connect components or circuitry between battery blocks 105, such as current collectors (for electrical terminals of different signs or the same sign), sense lines/traces, inputs/outputs (IOs) for a battery monitoring unit or sense board, data buses, or control circuitry. For example, a first plurality of ribbonbond interconnects 205 can provide a plurality of electrical pathways from at least one circuit component of the first battery block to at least one circuit component of the second battery block. The circuit components can include, but not limited to, the first current collector 130, the second current collector 135, sense lines embedded within the first current collector 130 or the second current collector 135, inputs for a battery monitoring unit, outputs for a battery monitoring unit, control circuitry, or a data bus coupled with a battery block 105. The ribbonbond interconnects 205 can couple between a positive terminal of a first battery block 105 and a negative terminal of a second battery block 105. The ribbonbond interconnects 205 can couple between a positive terminal of a first battery block 105 and a positive terminal of a second battery block 105. The ribbonbond interconnects 205 can couple between a negative terminal of a first battery block 105 and a negative terminal of a second battery block 105.

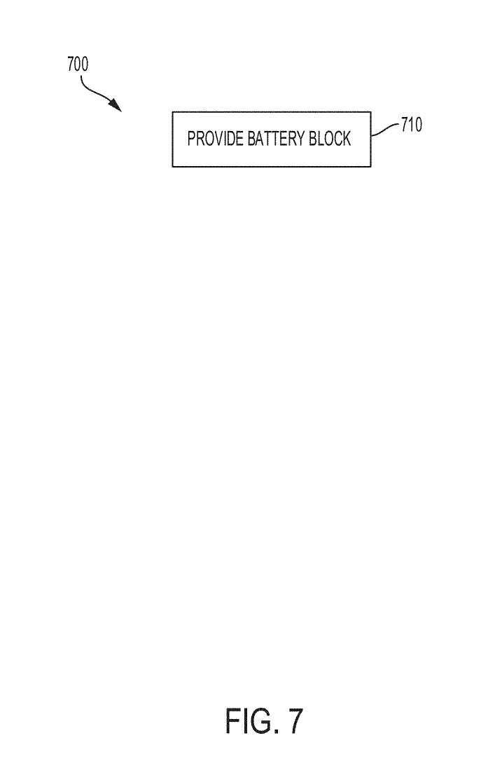

FIG. 7, among others, depicts an example embodiment of a method 700 for interconnecting battery blocks 105. The method 700 can include providing at least one battery block 105 (ACT 710). For example, interconnected battery blocks 105 to power the electric vehicle 505 can be provided. Each battery block 105 can include a plurality of battery cells 110 electrically connected and physically arranged to form a battery module 100 for storing energy. The plurality of battery blocks 105 can include a first battery block 105 and a second battery block 105. A first plurality of ribbonbond interconnects 205 can electrically connect a first current collector of a first battery block 105 with a second current collector of a second battery block 105. Each ribbonbond interconnect 205 can include a flexible metallic strip. The flexible metallic strip can provide a flexible physical connection between the first battery block 105 and the second battery block 105 to allow movement between the first battery block 105 and the second battery block 105. The flexible metallic strip can break an electrical connection between the first battery block 105 and the second battery block 105 responsive to an electrical current in the corresponding ribbonbond interconnect 205 exceeding a threshold. The threshold can be lower than a first battery block threshold for breaking an electrical connection between a terminal of one of the plurality of battery cells 110 and the current collector of the first battery block 105.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example the voltage across terminals of battery cells can be greater than 5V. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative polarities or electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system to interconnect battery blocks to provide electrical power to electric vehicles, comprising:
a plurality of battery blocks in an electric vehicle to power the electric vehicle;
each of the plurality of battery blocks comprising a plurality of battery cells electrically connected and physically arranged to form a battery module for storing energy;
a first plurality of ribbonbond interconnects to electrically connect a current collector of a first battery block of the plurality of battery blocks with a current collector of a second battery block of the plurality of battery blocks;
each ribbonbond interconnect comprising a flexible metallic strip to:
provide a flexible physical connection between the first battery block and the second battery block to allow movement between the first battery block and the second battery block; and
break an electrical connection between the first battery block and the second battery block responsive to an electrical current in the corresponding ribbonbond interconnect exceeding a threshold, the threshold lower than a threshold of the first battery block for breaking an electrical connection between a terminal of one of the plurality of battery cells of the first battery block and the current collector of the first battery block.

2. The system of claim 1, comprising:
a first ribbonbond interconnect of the first plurality of ribbonbond interconnects having a physical length to allow up to a defined level of movement between the first battery block and the second battery block while physically connecting the first battery block with the second battery block.

3. The system of claim 1, comprising:
a first portion of a first ribbonbond interconnect of the first plurality of ribbonbond interconnects welded to a portion of the first battery block, and a second portion of the first ribbonbond interconnect welded to a portion of the second battery block.

4. The system of claim 3, comprising:
the portion of the first battery block and the portion of the second battery block being offset in position by at least a predetermined distance along edges of the first battery block and edges of the second battery block that are closest to the welded first ribbonbond interconnect.

5. The system of claim 1, comprising:
a first ribbonbond interconnect of the first plurality of ribbonbond interconnects having a coating of a material over the metallic strip.

6. The system of claim 5, comprising:
the plurality of battery blocks electrically coupled in series via the first plurality of ribbonbond interconnects, to form a current path having a defined shape.

7. The system of claim 1, comprising:
a second plurality of ribbonbond interconnects to electrically connect a current collector of a third battery block to a current collector of a fourth battery block.

8. The system of claim 1, comprising:
a first ribbonbond interconnect of the first plurality of ribbonbond interconnects to connect to edges of the first battery block and the second battery block at an angle less than a perpendicular angle relative to the edges of the first battery block and the second battery block.

9. The system of claim 1, comprising:
a first ribbonbond interconnect of the first plurality of ribbonbond interconnects to connect to edges of the first battery block and edges of the second battery block at a first angle relative to the edges; and
a second ribbonbond interconnect of the first plurality of ribbonbond interconnects to connect to the edges at a second angle relative to the edges of the first battery block and the edges of the second battery block.

10. The system of claim 1, comprising:
the first plurality of ribbonbond interconnects provide a plurality of electrical pathways from the current collector of the first battery block to the current collector of the second battery block.

11. The system of claim 1, comprising:
the first plurality of ribbonbond interconnects provide a plurality of electrical pathways from at least one circuit component of the first battery block to at least one circuit component of the second battery block.

12. The system of claim 1, comprising
at least one surface of a first ribbonbond interconnect of the first plurality of ribbonbond interconnects disposed over at least one surface of a second ribbonbond interconnect of the plurality of ribbonbond interconnects to form a stacked portion of the first plurality of ribbonbond interconnects.

13. A method of interconnecting battery blocks to power electric vehicles, the method comprising:
arranging a plurality of battery blocks relative to each other in an electric vehicle to power the electric vehicle, each of the plurality of battery blocks comprising a plurality of battery cells electrically connected and physically arranged to form a battery module for storing energy;
producing a first plurality of ribbonbond interconnects according to the arrangement, each of the first plurality of ribbonbond interconnects having a threshold for electrical current flow; and
electrically connecting a current collector of a first battery block of the plurality of battery blocks with a current collector of a second battery block of the plurality of battery blocks using the first plurality of ribbonbond interconnects, each of the ribbonbond interconnects comprising a flexible metallic strip to:
provide a flexible physical connection between the first battery block and the second battery block; and
break an electrical connection between the first battery block and the second battery block when an electrical current in the corresponding ribbonbond interconnect exceeds the threshold, the threshold lower than a first battery block threshold for breaking an electrical connection between a terminal of one of the plurality of battery cells and a first current collector of the first battery block.

14. The method of claim 13, comprising:
producing a first ribbonbond interconnect of the first plurality of ribbonbond interconnects to have a physical length to allow up to a defined level of movement between the first battery block and the second battery block while physically connecting the first battery block with the second battery block;
welding a first portion of the first ribbonbond interconnect of the first plurality of ribbonbond interconnects to a portion of the first battery block; and
welding a second portion of the first ribbonbond interconnect to a portion of the second battery block.

15. The method of claim 13, comprising:
arranging the portion of the first battery block and the portion of the second battery block to be offset in position by at least a predetermined distance along edges of the first battery block and edges of the second battery block that are closest to the welded first ribbonbond interconnect.

16. The method of claim 13, comprising:
electrically coupling the plurality of battery blocks in series via the first plurality of ribbonbond interconnects, to form a current path having a defined shape.

17. The method of claim 13, comprising:
electrically coupling a second plurality of ribbonbond interconnects with a current collector of a third battery block of the plurality of battery blocks with a current collector of a fourth battery block of the plurality of battery blocks.

18. The method of claim 13, comprising:
coupling a first ribbonbond interconnect of the first plurality of ribbonbond interconnects to edges of the first battery block and the second battery block at an angle less than a perpendicular angle relative to the edges of the first battery block and the second battery block.

19. The method of claim 13, comprising:
coupling a first ribbonbond interconnect of the first plurality of ribbonbond interconnects to edges of the first battery block and the second battery block at a first angle relative to the edges; and
coupling a second ribbonbond interconnect of the first plurality of ribbonbond interconnects to the edges at a second angle relative to the edges.

20. An electric vehicle, comprising:
a plurality of battery blocks disposed in the electric vehicle to power the electric vehicle;
each of the plurality of battery blocks comprising a plurality of battery cells electrically connected and physically arranged to form a battery module for storing energy;
a first plurality of ribbonbond interconnects to electrically connect a current collector of a first battery block of the plurality of battery blocks with a current collector of a second battery block of the plurality of battery blocks;
each ribbonbond interconnect comprising a flexible metallic strip to:
provide a flexible physical connection between the first battery block and the second battery block to allow movement between the first battery block and the second battery block; and
break an electrical connection between the first battery block and the second battery block responsive to an electrical current in the corresponding ribbonbond interconnect exceeding a threshold, the threshold lower than a threshold of the first battery block for breaking an electrical connection between a terminal of one of the plurality of battery cells of the first battery block and the current collector of the first battery block.
